(19) United States
(12) Patent Application Publication
(10) Pub. No.: US 2026/0168295 A1
(43) Pub. Date: Jun. 18, 2026

(54) VEHICLE DOOR LATCH

(71) Applicant: Minebea AccessSolutions France, Alfortville (FR)

(72) Inventors: Jean-Philippe HOCHART, Alfortville (FR); Gregoire BIDAUT, Alfortville (FR); Etienne THOLLON-POMMEROL, Alfortville (FR)

(73) Assignee: Minebea AccessSolutions France, Alfortville (FR)

(21) Appl. No.: 19/418,137

(22) Filed: Dec. 12, 2025

(30) Foreign Application Priority Data
Dec. 13, 2024 (EP) 24315578

(51) Int. Cl. E05B 81/14; E05B 81/06; E05B 81/30; E05B 81/34

(52) U.S. Cl. CPC E05B 81/14; E05B 81/06; E05B 81/30; E05B 81/34

(57) ABSTRACT

A vehicle door latch including a claw with a first and a second catching surfaces and able to rotate, a pivoting pawl to abut against the claw, and a pawl lever mobile from a rest position to at least one opening position. The vehicle door latch also includes a stopper to interact with the pawl lever and to block a movement of the pawl lever when reaching a first opening position, the claw being in an intermediate position such that the pawl can engage the second catching surface, and a declutch mechanism to cause a motion of the stopper allowing the movement of the pawl lever to reach a second opening position beyond the first opening position such that the pawl disengages the claw.

### TECHNICAL FIELD

The present invention relates to the field of vehicle door latches to ensure the closing of vehicle doors. The invention more particularly pertains to a latch for opening/closing a hood of a vehicle.

### BACKGROUND OF THE INVENTION

Electric vehicles are becoming increasingly common in the automotive sector. The absence of an engine enables the use of the space under the hood for instance as a storage compartment.

Regulations applicable to the hood require particularly an intermediate hook when opening the hood, to release the latch in two steps, so that the hood can be opened completely if the vehicle is stopped but if the vehicle speed exceeds a threshold (for instance 5 km/h) the latch is only opened at a safety catch (or secondary position).

Currently, the hood is secured with a mechanical latch, by operating one handle inside the vehicle cabin to open the hood and then, outside of the vehicle, a safety hook between the hood and the front of the vehicle bumper can be pushed to open the hood. The opening is made with at least two separate inputs, one being in the vehicle the other one being outside the vehicle. There is a need to access the compartment under the hood with a new sequence.

In these respects, the aim of the invention is to provide a latch for a vehicle door, especially the hood, developed for the purpose of opening in two steps, with at least one input, offering an intermediate catch after a first movement.

### SUMMARY OF THE INVENTION

The present invention refers to a vehicle door latch comprising a claw configured to rotate and to engage with a striker of the vehicle door, a pivoting pawl configured to abut against said claw to prevent a rotation of said claw, and a pawl lever configured to pivot said pawl. The pawl lever is mobile from a rest position to at least one opening position.

According to the invention, said claw comprises a first and a second catching surfaces, and is configured to rotate at least between: a closed position (primary position) wherein the pawl abuts against the first catching surface, an intermediate position (secondary position) wherein the pawl abuts against the second catching surface, and an opened position wherein the pawl disengages the claw.

The vehicle door latch further comprises a stopper configured to interact with the pawl lever and to block a movement of the pawl lever when reaching a first opening position, the claw being in the intermediate position such that the pawl can engage the second catching surface,

The vehicle door latch further comprises a declutch mechanism configured to cause a motion of the stopper allowing the movement of the pawl lever to reach a second opening position beyond the first opening position such that the pawl disengages the claw.

Such a latch offers an intermediate catch after a first motion, by blocking the rotation of the pawl, namely the stopper blocks the rotation of the pawl lever, and the pawl blocks the claw in the intermediate position. There is no need to block the claw rotation with an additional part. And then, after declutching, a greater rotation of the pawl is allowed during a second motion.

The vehicle door latch may be configured for a hood or front trunk of the vehicle.

The pawl lever may define a primary stroke and a secondary stroke for the stopper.

Said stopper may be mobile along the primary stroke allowing the pawl lever to pivot said pawl to reach the first opening position, the end of the primary stroke blocking the movement of the pawl lever.

Said stopper may be mobile along the secondary stroke, allowing the pawl lever to pivot said pawl to reach the second opening position.

The pawl lever may be configured to pivot from the rest position into the first opening position with a first angle, when the stopper is positioned in the primary stroke, and to pivot from the rest position into the second opening position with a second angle wider than the first angle, when the stopper is positioned in the secondary stroke.

The stopper may be formed on an end of a stopper lever with a rotation axis parallel to a rotation axis of the pawl.

The stopper may be configured to move from the primary stroke to the secondary stroke in the pawl lever along a direction perpendicular to the rotation axis of the pawl.

The stopper may be configured to move vertically.

The declutch mechanism may include a reset element configured to bring back the pawl lever to the rest position.

The declutch mechanism may be configured to cause a motion of the stopper from the primary stroke to the secondary stroke in the pawl lever when the pawl lever is brought back in the rest position while the claw rotates.

The vehicle door latch may comprise an electric motor to drive the pawl lever to pivot said pawl both into the first opening position and into the second opening position.

The reset element may include the electric motor, Said electric motor being configured to rotate in a direction to drive the pawl lever to pivot said pawl into both opening positions and to rotate in an opposite direction to turn back the pawl lever to the rest position.

The reset element may include at least a spring.

The spring may have a first end mechanically linked to the claw and a second end including the stopper.

The vehicle door latch may comprise an additional lever, with a first end mechanically linked to the claw and a second end including the stopper.

The spring may be arranged to push the additional lever.

The pawl lever may include a through-hole opening in which the stopper engages, with at least a first stop. The through-hole opening may have a second stop.

The vehicle door latch may comprise a drive mechanism configured to drive the pawl lever, by form cooperation, at least twice, with two different rotation angles to the first opening position and to the second opening position.

The drive mechanism may comprise at least a first pin and a second pin.

Each pin may project from a different side of a gear wheel of the drive mechanism.

The first and the second pins may be configured to cooperate with a respective first contact zone and second contact zone in the pawl lever, to drive the pawl lever respectively to the first opening position with a first rotation angle, and to the second opening position with a second rotation angle greater than the first rotation angle.

The gear wheel may be configured to rotate and to drive in rotation the pawl lever with the first rotation angle to the first opening position, when the first pin abuts against a first contact zone in the pawl lever, until the stopper blocks the movement of the pawl lever.

When the declutch mechanism allows again the movement of the pawl lever, the gear wheel may be configured to rotate, the first pin may be configured to lose contact with the first contact zone, and the rotation of the gear wheel may be configured to drive in rotation the pawl lever with the second rotation angle to the second opening position when the second pin abuts against a second contact zone in the pawl lever, until the pawl disengages the claw and the second pin loses contact with the second contact zone.

The first pin and the second pin may be arranged on either side of the gear wheel, being angularly offset or shifted.

The pawl lever may have a recess delimitated by a first face forming the first contact zone, such that in the closed position, the first pin is in front of the recess in the pawl lever.

The pawl lever may have a protrusion, on the side defining the primary stroke and the secondary stroke for the stopper, the protrusion extending such that the protrusion and the recess are arranged opposite to each other.

The protrusion may be delimitated by a second face forming the second contact zone.

The first face and the second face, forming said contact zones in the pawl lever, may be offset from each other.

The invention also relates to a vehicle door comprising a vehicle door latch as defined above.

Said door may be a hood or a front trunk.

### BRIEF DESCRIPTION OF THE DRAWINGS

The invention will be better understood on reading the following description, which is given by way of example only and with reference to the attached drawings in which:

FIG. 1a is a perspective view of a vehicle door latch according to an embodiment of the present invention in a closed position (primary position).

FIG. 1b is a perspective view of the vehicle door latch in a half-latched position (secondary position).

FIG. 1c is a perspective view of the vehicle door latch in an opened position.

FIG. 2 is rear perspective view of parts of a vehicle door latch in the closed position according to another embodiment with a reset spring.

FIG. 3a is another view of parts of the vehicle door latch in the closed position of FIG. la, showing a drive mechanism comprising a gear wheel.

FIG. 3b shows a first pin of the gear wheel cooperating with a first contact zone of a pawl lever.

FIG. 3c shows a second pin of the gear wheel cooperating with a second contact zone of the pawl lever.

FIG. 4a is a perspective view of the gear wheel.

FIG. 4b is a side view of the gear wheel.

FIG. 5 is a perspective view of a part of the pawl lever comprising respective faces for cooperating with pins projecting from the gear wheel.

In these figures, identical elements have the same reference numbers.

### DETAILED DESCRIPTION OF THE INVENTION

The following embodiments are examples. Although, the specification refers to one or several embodiments, it does not imply that each reference refers to the same embodiment or that the features apply only to a single embodiment. Simple features of different embodiments can also be combined to provide other embodiments.

In the description, some elements may be indexed, for example first element or second element. The indexing is used to differentiate and name elements that are close but not identical. Such indexing does not imply a priority between several elements, and these denominations can be easily interchanged without departing from the scope of the present invention.

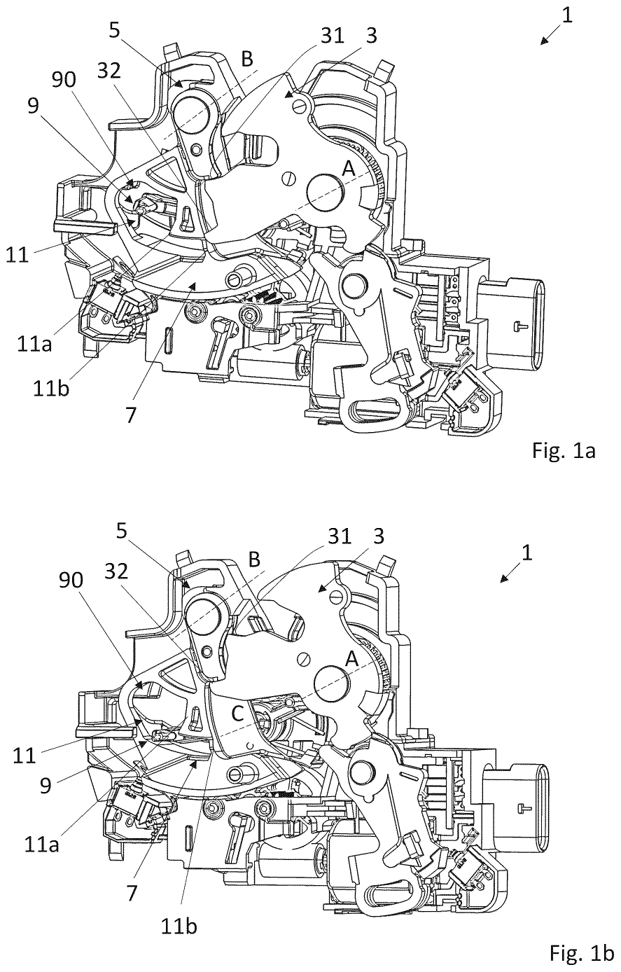

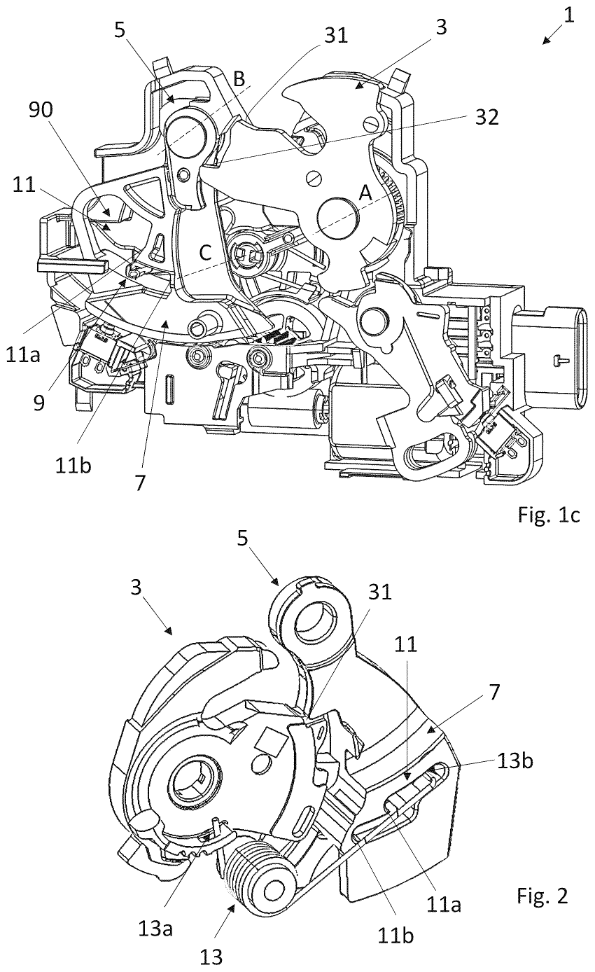

The present invention refers to a vehicle door latch 1 (FIG. 1a to FIG. 3a) configured to ensure the closing of a vehicle door. The term “door” is used in its widest sense to indicate any member movable between an open and a closed position to open and close an access opening to an internal compartment of a vehicle, and therefore includes hoods and rear doors, trunks, or front trunks, also known as “frunks”, in addition to the vehicle side doors.

The vehicle door latch 1 is especially suitable for a hood or front trunk or similar.

Further, the vehicle door latch 1 may be electric or mechanical.

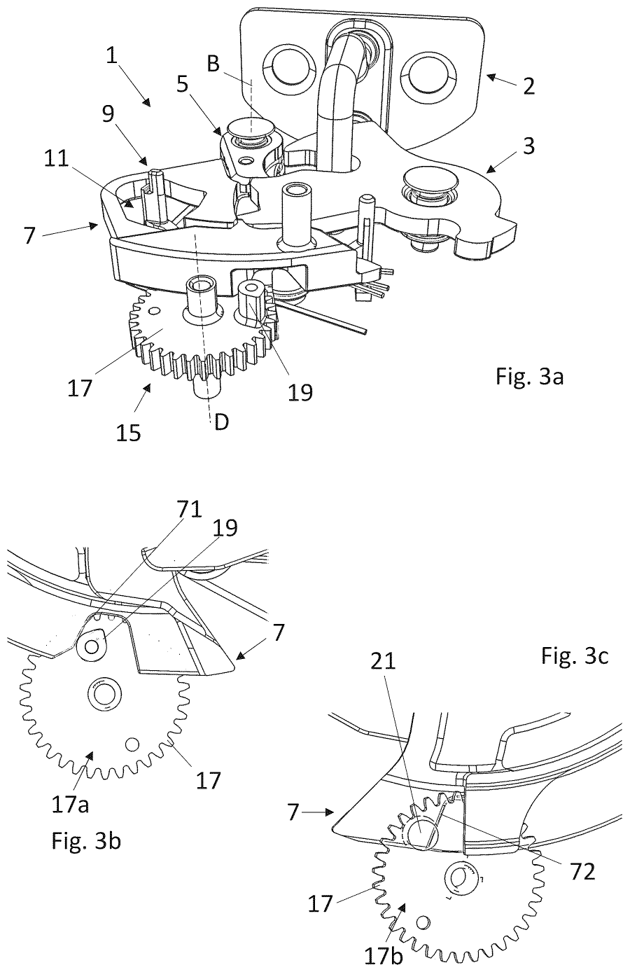

The vehicle door latch 1 is intended to be arranged in a door panel and is configured to interact with a striker 2 (shown FIG. 3a) intended to be fixed to the vehicle body next to the door. The striker 2 may be arranged and configured to be introduced into a recess of the vehicle door latch 1 when the vehicle door is closed. When the vehicle door is open, the striker 2 may be disengaged from the vehicle door latch 1.

FIG. 1a to FIG. 1c represent an example of such a vehicle door latch 1 respectively in a closed position, a half-latched position and an open position.

For instance, the vehicle door latch 1 can be opened only in the half-latched position (first opening/first release) when the vehicle drives, particularly when the speed of the vehicle is greater than a predefined speed threshold such as 5 km/h. The vehicle door latch 1 can open completely (second opening) if the vehicle is stopped or at a speed lower than the predefined speed threshold such as 5 km/h.

The vehicle door latch 1 comprises a claw 3, a pivoting pawl 5, and a pawl lever 7.

The claw 3 is configured to engage with the striker (not shown) of the vehicle door when the latter is closed.

Such claw 3 comprises at least a first catching surface 31 and a second catching surface 32.

The second catching surface 32 is on a same area of the same claw 3 than the first catching surface 31. This second catching surface 32 is not on another lever for instance.

The claw 3 is also configured to rotate around a rotation axis A, at least between a first position also called closed position (primary position) (FIG. 1a), a second position also called an intermediate position (secondary position) (FIG. 1b), and a third position also called an opened position (FIG. 1c).

The pivoting pawl 5 is configured to pivot around a rotation axis B, which may be parallel to the rotation axis A of the claw 3, being driven by the pawl lever 7.

The pawl 5 is configured to abut against the claw 3, particularly against one catching surface 31 or 32, to prevent a rotation of the claw 3.

More precisely, in the closed position of the vehicle latch 1 (FIG. 1a), the pawl 5 abuts against the first catching surface 31 of the claw 3 which is blocked in its first or closed position. Thus, the pawl 5 blocks the rotation of the claw 3 so that the striker can be retained by the claw 3.

In the half-latched position of the vehicle latch 1 (FIG. 1b), the pawl 5 abuts against the second catching surface 32 of the claw 3 which is blocked in its second or intermediate position.

In the open position of the vehicle latch 1 (FIG. 1c), the pawl 5 disengages the claw 3, which is then in its third or open position. The pawl 5 thus enables the rotation of the claw 3 and therefore the release of the striker to open the door.

The pawl lever 7, also referred to as a boot, is configured to pivot the pawl 5. The pawl lever 7 is mobile between a rest position (FIG. 1a) and a first opening position (FIG. 1b) or a second opening position (FIG. 1c).

The pawl lever 7 is configured to pivot from the rest position (FIG. 1a) into the first opening position (FIG. 1b) with a first angle. The pawl lever 7 is configured to pivot from the rest position into the second opening position (FIG. 1c) with a second angle wider than the first angle.

The first catching surface 31 and the second catching surface 32 may be arranged on the area of the claw 3 such that the difference is less than 15°, for instance between 5° and 10°, for instance around 9°, between the first and the second opening positions of the pawl lever 7.

The pawl lever 7 can be driven or activated mechanically or electrically.

When the vehicle door latch 1 is electric, a same electric motor may drive the pawl lever 7 to pivot the pawl 5, both in the first opening position (FIG. 1b) and in the second opening position (FIG. 1c). Thus, only one electric input is sufficient contrary to the prior art solution with first a handle to be pulled and then a safety hook.

The pawl lever 7 can be linked to a shaft of the electric motor through at least one gear wheel or crank pin configured to interact with surfaces/recesses in the pawl lever 7, an example being described afterwards.

When the vehicle door latch 1 is electric, a mechanical back-up mechanism can be provided.

When the vehicle door latch 1 is mechanical, the pawl lever 7 may be intended to be linked mechanically to a mechanical handle (not shown) of the vehicle. Such a handle may be configured to be manipulated or maneuvered to activate the pivoting of the pawl lever 7 both into the first opening position (FIG. 1b) and into the second opening position (FIG. 1c). In other words, the vehicle door latch 1 can be open in the half-latched position (FIG. 1b) and in the completely open position (FIG. 1c), by pulling twice on the same mechanical handle. Thus, only one mechanical input is sufficient contrary to the prior art solution with first a handle to be pulled and then a safety hook.

The handle can be an inner handle inside the vehicle, for instance in the cabin. As a variant, the handle can be outside the vehicle.

The pawl lever 7 can be linked mechanically to the mechanical handle through at least one rod or a Bowden cable.

### Stopper and Declutch Mechanism

The vehicle door latch 1 further comprises a stopper 9 configured to interact with the pawl lever 7, specifically to block or allow a movement of the pawl lever 7.

The stopper 9 can block the movement of the pawl lever 7 when the latter reaches the first opening position (FIG. 1b), while the claw 3 is in its intermediate position such that the pawl 5 engages the second catching surface 32.

When the pawl lever 7 is blocked in the first opening position (FIG. 1b), this limits the rotation of the claw 3 beyond its intermediate position, with a small/limited opening. The vehicle door latch 1 is then open but still blocked.

Blocking further pivoting of the pawl lever 7 prevents a complete release of the claw 3, which offers a safety position as the driver is not blinded because of a hood or “frunk” inadvertently opened. An alert / warning may possibly be transmitted through the dashboard.

Moreover, the vehicle door latch 1 comprises a declutch mechanism configured to cause a motion of the stopper 9 such that it allows the movement of the pawl lever 7 to reach a second opening position (FIG. 1b) which is beyond the first opening position (FIG. 1b) such that the pawl 5 driven by the pawl lever 7 can disengage the claw 3.

With a first motion, the pawl lever 7 drives the pawl 5 so that it disengages from the first catching surface 31 to the second catching surface 32 of the claw 3. After this first motion, the stopper 9 blocks the movement of the pawl lever 7, it does not block the claw 3 which is instead blocked by the pawl 5.

Then, the declutch mechanism allows a second motion of the pawl lever 7 such that the pawl 5 disengages the claw 3 which can then freely rotate until a complete open position (FIG. 1c).

Moreover, the stopper 9 is mobile along a primary stroke and a secondary stroke.

The pawl lever 7 may define the primary stroke and the secondary stroke for the stopper 9.

For instance, the pawl lever 7 includes a through-hole opening 11 in which the stopper 9 engages.

The through-hole opening 11 has at least a first stop 11a. The first stop 11a defines an end of the primary stroke on which the stopper 9 may abut. The through-hole opening 11 may also define a surface 11b. There is clearance between such a surface 11b and the stopper 9 at the end of the secondary stroke.

When the stopper 9 is positioned in the primary stroke, the pawl lever 7 can pivot the pawl 5 to reach the first opening position (FIG. 1b), with the first angle. The end of the primary stroke blocks the movement of the pawl lever 7. This prevents a wider rotation of the pawl lever 7 to the second opening position.

But, when the stopper 9 is positioned in the secondary stroke, the pawl lever 7 can pivot the pawl 5 to reach the second opening position (FIG. 1c), with the second angle, wider than the first angle. The second stroke forms an over-stroke allowing the pawl lever 7 to rotate completely, as explained afterwards.

The vehicle door latch 1 may include an additional lever 90, such as a pivoting lever, which may have a first end mechanically linked to the claw 3 and a second end including the stopper 9. A spring may be arranged to push the additional lever against the claw 3.

The spring may be arranged between a housing of the vehicle door latch 1 and the additional lever. For example, the spring may be arranged around a central portion of the additional lever. The motion of the additional lever is thus driven by the rotation of the claw 3. The lever may be rigid, it can be made at least partially in plastic.

According to an embodiment, the stopper 9 may be formed on the end of a pivoting lever forming a stopper lever 90. For example, the stopper lever 90 can pivot around a rotation axis C which may be parallel to the rotation axis B of the pawl 5. The stopper 9 may form a protuberance, for instance an axial protuberance extending mainly parallel to the rotation axis B, C.

According to another embodiment, the stopper 9 may be formed by a pin.

Particularly, the stopper 9 can be arranged such that it can move or cross from the primary stroke to the secondary stroke in the pawl lever 7 along a direction perpendicular to the rotation axis B, C. The stopper 9 may be configured to move vertically from the primary stroke to the secondary stroke, according to the orientation of elements in FIGS. 1a to 1c.

Besides, the declutch mechanism includes a reset element configured to bring back the pawl lever 7 to the rest position.

In operation, the declutch mechanism is configured to cause a motion of the stopper 9 (FIGS. 1a to 1c) from the primary stroke to the secondary stroke, when the pawl lever 7 is brought back in the rest position while the claw 3 rotates. In other words, the stopper 9 is positioned out of the primary stroke and in the secondary stroke in the pawl lever 7, when the pawl lever 7 is brought back to the rest position while the claw 3 rotates until the pawl 5 engages the second catching surface 32.

The reset element may include for instance at least a spring 13 as represented in FIG. 2. The spring 13 may work in compression.

The spring 13 may comprise a first end 13a and a second end 13b.

The first end 13a of the spring 13 may be mechanically linked to the claw 3, for instance received in an aperture in the claw 3. This first end 13a may be arranged to be blocked in rotation with the claw 3.

The second end 13b of the spring 13 may contact the pawl lever 7. In particular, the second end 13b may include or form the stopper 9.

The rotation of the claw 3 is transferred to the spring 13 such that the second end 13b including the stopper 9 moves along the primary or secondary stroke in the pawl lever 7. At first, the spring 13 may apply no torque. When the claw rotates 3, this rotation may put torque on the spring 13.

The other features described above regarding the first stroke and second stroke of the stopper 9 apply to this embodiment when formed by the second end 13b of the spring 13.

As a variant, the reset element may include an electric motor configured to rotate in one direction to drive the pawl lever 7 to pivot into both opening positions and to rotate in an opposite direction to turn back the pawl lever 7 to the rest position. Namely, the electric motor is a reversible motor with an output shaft that can be rotated in a clockwise or a counterclockwise direction.

According to the variant with an additional lever including the stopper 9 and a spring being arranged to push the additional lever, in operation, the contact of the additional lever with the claw 3 may give the rest position.

### Drive Mechanism

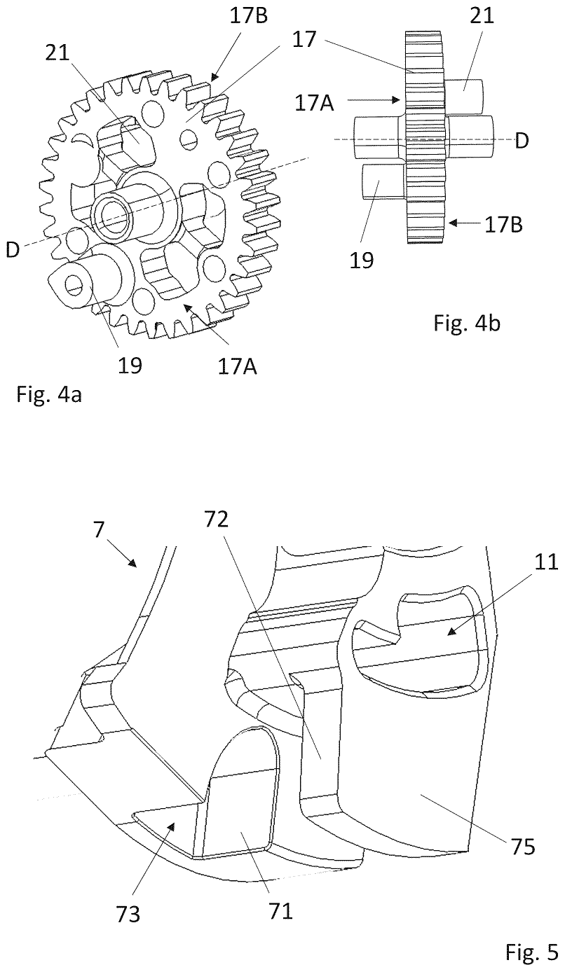

The vehicle door latch 1 further comprises a drive mechanism 15 (FIG. 3a to FIG. 4) configured to drive the pawl lever 7, by form cooperation, at least twice, with two different rotation angles from the rest position to the first opening position or to the second opening position.

The drive mechanism 15 may comprise a gear wheel (or crank) 17. The gear wheel 17 may be configured to do a 360° rotation. The pawl lever 7 is configured to be displaced by the gear wheel 17 when the latter rotates. The rotation axis D of the gear wheel 17 is parallel to the rotation axis B of the pawl lever 7.

The gear wheel 17 may comprise teeth at least on a portion of circle or around the whole circumference, for example to mesh with another gear wheel that may for instance cooperate with a worm arranged on the output shaft of a motor of the drive mechanism 15.

At least a first pin 19 and a second pin 21 may project from a different side 17A or 17B of the gear wheel 17, as can be best seen in FIG. 4a or FIG. 4b. Each pin 19, 21 forms a projection, especially an axial projection extending mainly parallel to the rotation axis D.

The first pin 19 and the second pin 21 are arranged on either side 17A, 17B of the gear wheel 17 while being angularly offset or shifted.

The pins 19, 21 are configured to come in contact with the pawl lever 7 when the gear wheel 17 rotates. More specifically, the pins 19, 21 are configured to cooperate with respective contact zones 71, 72 of the pawl lever 7 when the gear wheel 17 rotates. In operation, the first pin 19 can come in contact with a first contact zone 71 to drive the pawl lever 7 to the first opening position with a first rotation angle. The second pin 21 can come in contact with a second contact zone 72 to drive the pawl lever 7 to the second opening position with a second rotation angle greater than the first rotation angle.

When the vehicle door latch 1 is in the closed position (FIG. 3a), the gear wheel 17 is in its initial position. The pins 19, 21 are not in mechanical contact with the respective contact zones 71, 72 of the pawl lever 7.

Referring to FIG. 3a and FIG. 5, the pawl lever 7 may have a recess 73 or window.

The recess 73 may be designed in the pawl lever 7 such that in the closed position of the vehicle door latch 1, the first pin 19 stands in front of such recess 73.

The recess 73 is delimitated by several faces of the pawl lever 7, for example at least three faces. One of these faces may form the first contact zone 71. Such a face is referred to hereafter as a first face.

The pawl lever 7 may further have a protrusion 75, on the side defining the primary stroke and the secondary stroke for the stopper 9, namely the side with the through-hole opening 11 in which the stopper 9 engages.

The protrusion 75 extends such that the protrusion 75 and the recess 73 are arranged opposite to each other.

The protrusion 75 is delimitated by several faces of the pawl lever 7. One of these faces may form the second contact zone 72. Such a face is referred to hereafter as a second face.

The protrusion 75 may have a general parallelepiped shape, with two large faces joined by small faces, including two opposite small side faces and a small end face opposite the through-hole opening 11. The second face forming the second contact zone 72, can be a small side face of the parallelepiped shape.

The first face, forming the first contact zone 71, and the second face, forming the second contact zone 72, are offset from each other.

Thus, for the first opening or first release to get the vehicle door latch 1 in the half-latched position, the drive mechanism 15 is activated and the gear wheel 17 rotates from the initial position (FIG. 3a) so that the first pin 19 abuts against the first contact zone 71 in the pawl lever 7 (FIG. 3b). On the other side 17B, the second pin 21 is not in contact with the second contact zone 72 of the pawl lever 7. With the rotation of the gear wheel 17, the first pin 19 drives in rotation the pawl lever 7 with the first rotation angle, while the stopper 9 moves along the primary stroke, until the stopper 9 blocks the rotation of the pawl lever 7 as previously described. The pawl lever 7 is thus in the first opening position and the pawl 5 abuts against the second catching surface 32 of the claw 3 blocked in its intermediate position.

The complete opening (second opening/release) can occur when the declutch mechanism allows again the movement of the pawl lever 7 when the stopper 9 is placed or moves down in the secondary stroke, as previously described. The gear wheel 17 continues to rotate such that the first pin 19 loses contact with the first contact zone 71 and is freed from the recess or window 73. While the wheel 17 continues to rotate, the second pin 21 comes in contact with the pawl lever 7 (when abutting against the second contact zone 72). The rotation of the wheel 17 allows the second pin 21 to push the pawl lever 7 for the second release, by rotating with the second rotation angle to its second opening position, until the pawl 5 disengages the claw 3 and the second pin 21 loses contact with the second contact zone 72.

As an alternative (not shown) or in combination, the pawl lever 7 may have at least a projection or pin configured to come in contact with a contact zone defined by the wheel 17.

Thus, the vehicle door latch 1 according to any embodiment as described above, provides a new sequence to access for instance the compartment under the hood, offering a two-motion opening in a simple way with only one input needed.

In the closed position, the pawl 5 engages with the first catching surface 31 of the claw 3. When a first opening or first release is requested, the pawl lever 7 rotates, for example being driven by the contact of the first pin 19 of the wheel/crankpin, until the stopper 9 blocks the rotation of the pawl lever 7, and the pawl 5 engages with the second catching surface 32 in the same area of the claw 3 in the intermediate position. The door such as the hood is in an intermediate position between the closed position and the open position (the hood being a little open).

Then, after reset, the pawl 5 and the pawl lever 7 turn back into the rest position because of a spring or a reset motor, the pawl lever 7 and thus the pawl 5 can then have a wider rotation while the stopper 9 moves along the second bigger stroke, for example by being driven by the contact of the second pin 21 of the gear wheel/crankpin, to reach the full or complete opening.

1-16. (canceled)

17. A vehicle door latch, comprising:
a claw configured to rotate and to engage with a striker of the vehicle door;
a pivoting pawl configured to abut against said claw to prevent a rotation of said claw; and
a pawl lever configured to pivot said pawl, mobile from a rest position to at least one opening position,
wherein said claw comprises first and second catching surfaces, and is configured to rotate at least between:
a closed position wherein the pawl abuts against the first catching surface,
an intermediate position wherein the pawl abuts against the second catching surface, and
an open position wherein the pawl disengages the claw,
the vehicle door latch further comprises a stopper configured to interact with the pawl lever and to block a movement of the pawl lever when reaching a first opening position, the claw being in the intermediate position such that the pawl can engage the second catching surface, and
wherein the vehicle door latch further comprises a declutch mechanism configured to cause a motion of the stopper allowing the movement of the pawl lever to reach a second opening position beyond the first opening position such that the pawl disengages the claw.

18. The vehicle door latch according to claim 17, wherein:
the pawl lever defines a primary stroke and a secondary stroke for the stopper,
said stopper is mobile along the primary stroke allowing the pawl lever to pivot said pawl to reach the first opening position, an end of the primary stroke blocking the movement of the pawl lever, and
said stopper is mobile along the secondary stroke, allowing the pawl lever to pivot said pawl to reach the second opening position.

19. The vehicle door latch according to claim 18, wherein the stopper is formed on an end of a stopper lever with a rotation axis parallel to a rotation axis of the pawl, and the stopper is configured to move from the primary stroke to the secondary stroke in the pawl lever along a direction perpendicular to the rotation axis of the pawl.

20. The vehicle door latch according to claim 18, wherein the declutch mechanism includes a reset element configured to bring back the pawl lever to the rest position, the declutch mechanism being configured to cause a motion of the stopper from the primary stroke to the secondary stroke in the pawl lever when the pawl lever is brought back in the rest position while the claw rotates.

21. The vehicle door latch according to claim 20, further comprising an electric motor to drive the pawl lever to pivot said pawl both into the first opening position and into the second opening position, wherein the reset element includes the electric motor, said electric motor being configured to rotate in a direction to drive the pawl lever to pivot said pawl into both opening positions and to rotate in an opposite direction to turn back the pawl lever to the rest position.

22. The vehicle door latch according to claim 20, wherein the reset element includes a spring.

23. The vehicle door latch according to claim 22, wherein the spring has a first end mechanically linked to the claw and a second end including the stopper.

24. The vehicle door latch according to claim 22, further comprising an additional lever, with a first end mechanically linked to the claw and a second end including the stopper, the spring being arranged to push the additional lever.

25. The vehicle door latch according to claim 17, further comprising an electric motor to drive the pawl lever to pivot said pawl both into the first opening position and into the second opening position.

26. The vehicle door latch according to claim 17, wherein the pawl lever includes a through-hole opening in which the stopper engages, with at least a stop.

27. The vehicle door latch according to claim 17, further comprising a drive mechanism configured to drive the pawl lever, by form cooperation, at least twice, with two different rotation angles to the first opening position and to the second opening position.

28. The vehicle door latch according to claim 27, wherein:
the drive mechanism comprises at least a first pin and a second pin, each pin projecting from a different side of a gear wheel of the drive mechanism, and
the first and the second pins are configured to cooperate with a respective first contact zone and second contact zone in the pawl lever, to drive the pawl lever respectively to the first opening position with a first rotation angle, and to the second opening position with a second rotation angle greater than the first rotation angle.

29. The vehicle door latch according to claim 28, wherein:
the gear wheel is configured to rotate and to drive in rotation the pawl lever with the first rotation angle to the first opening position, when the first pin abuts against a first contact zone in the pawl lever, until the stopper blocks the movement of the pawl lever, and
when the declutch mechanism allows again the movement of the pawl lever, the gear wheel is configured to rotate, the first pin is configured to lose contact with the first contact zone, and the rotation of the gear wheel is configured to drive in rotation the pawl lever with the second rotation angle to the second opening position when the second pin abuts against a second contact zone in the pawl lever, until the pawl disengages the claw and the second pin loses contact with the second contact zone.

30. The vehicle door latch according to claim 28, wherein the first pin and the second pin are angularly offset.

31. The vehicle door latch according to claim 28, wherein:
the pawl lever defines a primary stroke and a secondary stroke for the stopper,
said stopper is mobile along the primary stroke allowing the pawl lever to pivot said pawl to reach the first opening position, an end of the primary stroke blocking the movement of the pawl lever,
said stopper is mobile along the secondary stroke, allowing the pawl lever to pivot said pawl to reach the second opening position,
the pawl lever has a recess delimitated by a first face forming the first contact zone, such that in the closed position, the first pin is in front of the recess in the pawl lever, and
the pawl lever has a protrusion, on the side defining the primary stroke and the secondary stroke for the stopper, the protrusion extending such that the protrusion and the recess are arranged opposite to each other, wherein the protrusion is delimitated by a second face forming the second contact zone.

32. The vehicle door latch according to claim 31, wherein the first face and the second face, forming said contact zones in the pawl lever, are offset from each other.
